(19) United States
(12) Patent Application Publication
(10) Pub. No.: US 2015/0009112 A1
(43) Pub. Date: Jan. 8, 2015

(54) LIQUID CRYSTAL DISPLAY DEVICE

(71) Applicant: Mitsubishi Electric Corporation, Tokyo (JP)

(72) Inventor: Kazunori OKUMOTO, Tokyo (JP)

(73) Assignee: MITSUBISHI ELECTRIC CORPORATION, Tokyo (JP)

(21) Appl. No.: 14/315,373

(22) Filed: Jun. 26, 2014

(30) Foreign Application Priority Data
Jul. 3, 2013 (JP) 2013-139473

(51) Int. Cl. G09G 3/36

(52) U.S. Cl. CPC G09G 3/3648
USPC 345/96

(57) ABSTRACT

The present invention includes first pixels formed to have a first slit having an inclination angle with respect to a rubbing direction and second pixels formed to have a second slit having an inclination angle opposite to the first slit, and at least one of the first pixels having a positive polarity allocated thereto and at least one of the first pixels having a negative polarity allocated thereto exist in the same frame, and at least one of the second pixels having the positive polarity allocated thereto and at least one of the second pixels having the negative polarity allocated thereto exist in the same frame.

### BACKGROUND OF THE INVENTION

1. Field of the Invention

The present invention relates to a liquid crystal display device, and more particularly, the present invention relates to a liquid crystal display device for controlling orientation directions of liquid crystal molecules using an electric field between electrodes provided on the same substrate.

2. Description of the Background Art

Means for increasing the viewing angle of a liquid crystal display device includes generating an electric field in the horizontal direction between electrodes provided on the same substrate and rotating the liquid crystal molecules within the plane parallel to the substrate using the electric field. Known examples using this means include in-plane switching (hereinafter referred to as IPS) method or fringe-field switching (hereinafter referred to as FFS) method which is an advanced version of the IPS method.

In the liquid crystal display device using the means explained above, the viewing angle is increased, but on the other hand, there is a problem in that, when the viewing angle changes, the color changes more greatly than other methods (color shift phenomenon).

A method for alleviating this color shift phenomenon is a method for forming slits extending with two different inclinations in a given pixel. When this method is used, however, an area where no electric field is generated in the liquid crystal layer (invalid area) is generated between two types of slits, and therefore, there is a problem in that the transmittance reduces.

In recent years, the resolution tends to increase significantly, and the existence of the invalid area which may reduce the transmittance is the problem. As the pixel size decreases, the ratio of the invalid area occupied in the screen relatively increases, and therefore, in a liquid crystal display device of a high resolution or of a small screen size, the invalid area affecting the reduction of the transmittance increases.

For such a problem, according to the configuration disclosed in Japanese Patent Application Laid-Open No. 2007-293154, slits extending with different inclinations are formed in the two pixels interposing a gate wire therebetween so that to prevent the color shift phenomenon as well as eliminate the invalid area, thus preventing the transmittance from reducing.

### SUMMARY OF THE INVENTION

The arrangement method of the two slits for preventing the color shift phenomenon described in Japanese Patent Application Laid-Open No. 2007-293154 is limited to a combination of two pixels with the gate wire interposed therebetween, and no other combination is not at all considered.

In this case, liquid crystal drive methods such as dot inversion drive method or line inversion drive method are intended to control the polarity in unit of pixel, and is also related to visibility (for example, flicker phenomenon). On the other hand, color materials are arranged in units of pixels, and it is to be understood that the color materials are related to the visibility.

Therefore, when the arrangement method of the slits is uniquely fixed, there is a problem in that the effect of eliminating the flicker phenomenon cannot be obtained or the effect of eliminating the color shift phenomenon cannot be obtained, depending on the drive method or the arrangement of the color materials.

An object of the present invention is to provide a liquid crystal display device for rotating and controlling liquid crystal molecules within a plane parallel to a substrate, wherein the liquid crystal display device can suppress the color shift phenomenon and can suppress the flicker phenomenon.

A liquid crystal display device according to an aspect of the present invention includes a plurality of pixels arranged on a substrate, and rotates and controls a liquid crystal molecule within a plane parallel to the substrate in each of the pixels, and each of the pixels includes a liquid crystal layer, a pixel electrode arranged below the liquid crystal layer, and a counter electrode arranged below the pixel electrode with an insulation film located therebetween.

Out of the plurality of the pixels, pixels having a first slit formed to have an inclination angle with respect to a rubbing direction in the pixel electrode are defined as first pixels, and pixels having a second slit formed to have an inclination angle opposite to the first slit with respect to the rubbing direction in the pixel electrode are defined as second pixels.

In a case where a positive polarity or a negative polarity is allocated to each of the pixels for each frame, at least one of the first pixels having the positive polarity allocated thereto and at least one of the first pixels having the negative polarity allocated thereto exist in the same frame, and at least one of the second pixels having the positive polarity allocated thereto and at least one of the second pixels having the negative polarity allocated thereto exist in the same frame.

A liquid crystal display device according to another aspect of the present invention includes a plurality of pixels arranged on a substrate, and rotates and controls a liquid crystal molecule within a plane parallel to the substrate in each of the pixels, and each of the pixels includes a liquid crystal layer, a pixel electrode arranged below the liquid crystal layer, and a counter electrode arranged below the pixel electrode with an insulation film located therebetween.

Out of the plurality of the pixels, pixels having a first slit formed to have an inclination angle with respect to a rubbing direction in the pixel electrode are defined as first pixels, and pixels having a second slit formed to have an inclination angle opposite to the first slit with respect to the rubbing direction in the pixel electrode is defined as second pixels.

In a case where any one of a plurality of types of color materials is allocated to each of the pixels, the plurality of types of color materials are all allocated to both of at least one of the first pixels and at least one of the second pixels.

A liquid crystal display device according to still another aspect of the present invention includes a plurality of pixels arranged on a substrate, and rotates and controls a liquid crystal molecule within a plane parallel to the substrate in each of the pixels, and each of the pixels includes a liquid crystal layer, a counter electrode arranged below the liquid crystal layer, and a pixel electrode arranged below the counter electrode with an insulation film located therebetween.

Out of the plurality of the pixels, pixels having a first slit formed to have an inclination angle with respect to a rubbing direction in the counter electrode are defined as first pixels, and pixels having a second slit formed to have an inclination angle opposite to the first slit with respect to the rubbing direction in the counter electrode are defined as second pixels.

In a case where a positive polarity or a negative polarity is allocated to each of the pixels for each frame, at least one of the first pixels having the positive polarity allocated thereto and at least one of the first pixels having the negative polarity allocated thereto exist in the same frame, and at least one of the second pixels having the positive polarity allocated thereto and at least one of the second pixels having the negative polarity allocated thereto exist in the same frame.

A liquid crystal display device according to still another aspect of the present invention includes a plurality of pixels arranged on a substrate, and rotates and controls a liquid crystal molecule within a plane parallel to the substrate in each of the pixels, and each of the pixels includes a liquid crystal layer, a counter electrode arranged below the liquid crystal layer, and a pixel electrode arranged below the counter electrode with an insulation film located therebetween.

Out of the plurality of the pixels, pixels having a first slit formed to have an inclination angle with respect to a rubbing direction in the counter electrode are defined as first pixels, and pixels having a second slit formed to have an inclination angle opposite to the first slit with respect to the rubbing direction in the counter electrode are defined as a second pixel.

In a case where any one of a plurality of types of color materials is allocated to each of the pixels, the plurality of types of color materials are all allocated to both of at least one of the first pixels and at least one of the second pixels.

According to the aspects of the present invention explained above, the polarities and all of the color materials are allocated to both of at least one of the first pixels and at least one of the second pixels, so that the color shift phenomenon can be prevented, and the flicker phenomenon can be prevented.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a plan view illustrating a planar configuration of a liquid crystal display device (liquid crystal display panel) according to a preferred embodiment;

FIG. 2 is a plan view illustrating a configuration of a pixel unit formed in a display area;

FIG. 3 is a diagram illustrating a cross sectional view in an arrow direction taken along P-P′ of FIG. 2;

FIG. 4 is a diagram illustrating an arrangement of TFTs formed in the display area on a TFT array substrate of the liquid crystal display device according to the preferred embodiment;

FIG. 5 is a diagram illustrating an arrangement of polarities of pixels and color materials during line inversion driving in the liquid crystal display device according to the preferred embodiment;

FIGS. 6 to 9 are diagrams illustrating pixels A and pixels B in the liquid crystal display device according to the preferred embodiment.

FIG. 10 is a diagram illustrating an arrangement of TFTs formed in the display area on a TFT array substrate of the liquid crystal display device according to the preferred embodiment;

FIG. 11 is a diagram illustrating an arrangement of polarities of pixels and color materials during column inversion driving in the liquid crystal display device according to the preferred embodiment; and

FIGS. 12 to 14 are diagrams illustrating pixels A and pixels B in the liquid crystal display device according to the preferred embodiment.

### DESCRIPTION OF THE PREFERRED EMBODIMENTS

While the invention has been shown and described in detail, the foregoing description is in all aspects illustrative and not restrictive. It is therefore understood that numerous modifications and variations can be devised without departing from the scope of the invention.

Preferred embodiments will be hereinafter explained with reference to appended drawings.

### First Preferred Embodiment

<Configuration>

An example of application to a liquid crystal display panel in an FFS (Fringe Field Switching) mode will be explained as the first preferred embodiment.

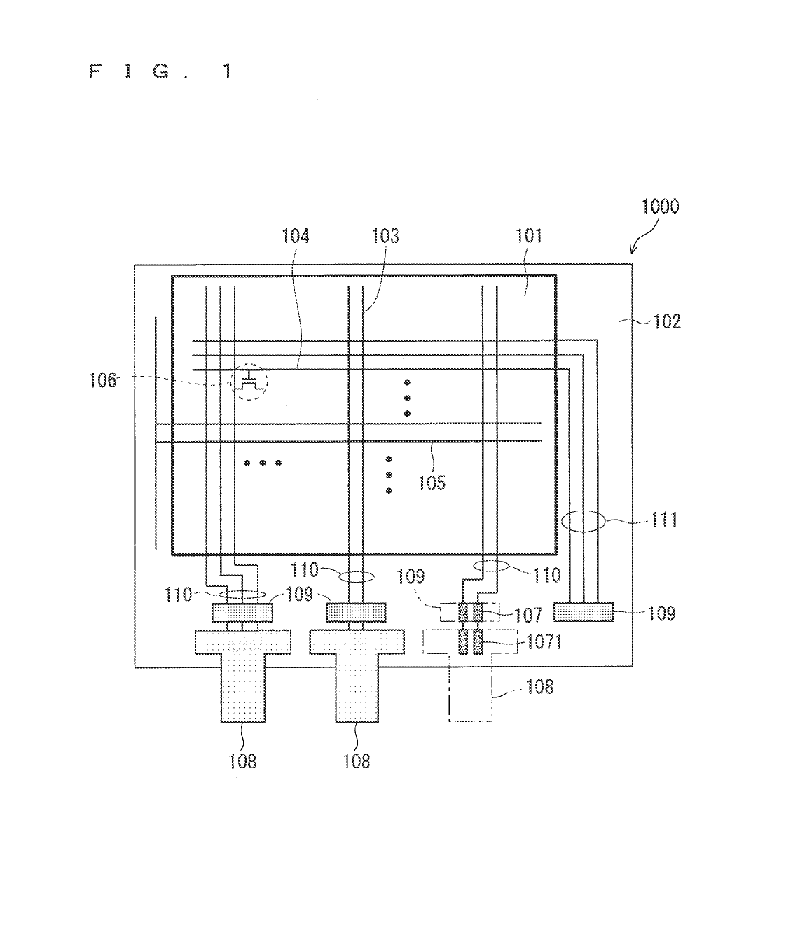

FIG. 1 is a plan view illustrating a planar configuration of a liquid crystal display panel 1000 according to the present preferred embodiment. It should be noted that the drawings are all in a schematic manner, and do not reflect the accurate sizes of the constituent elements shown therein. In order to avoid complexity, some of the configurations are omitted or simplified.

As shown in FIG. 1, the liquid crystal display panel 1000 includes a display area 101 for displaying an image and a frame area 102 provided so as to enclose the display area 101.

The display area 101 is provided with a plurality of signal lines 103 and a plurality of scanning lines 104 which cross each other (which are perpendicular to each other). A portion where a signal line 103 and a scanning line 104 cross each other will be defined as a cross portion. A plurality of common wires 105 are arranged parallel to the scanning lines 104.

An area enclosed by a signal line 103 and a scanning line 104 adjacent to each other (an area enclosed by the cross portions) constitutes one pixel unit. Therefore, in the display area 101, a plurality of pixel units are arranged in a matrix manner.

A thin film transistor 106 is provided at the cross portion of the signal line 103 and the scanning line 104, and this makes such a configuration that one thin film transistor 106 is provided for one pixel.

In the frame area 102, a plurality of implementation terminals 107 and a plurality of external connection terminals 1071 are provided. The implementation terminals 107 are connected to extraction wires 110 extending from the signal lines 103 in the display area 101 and the extraction wires 111 extending from the scanning lines 104 in the display area 101. Each of the external connection terminals 1071 is connected to the implementation terminals 107. The plurality of common wires 105 are bound in the frame area 102, and a common electrical potential is configured to be given thereto.

The implementation terminals 107 are connected to an IC (integrated circuit) chip 109 for signal control, and the external connection terminals 1071 are connected to a wire substrate 108 such as an FPC (Flexible Printed Circuit).

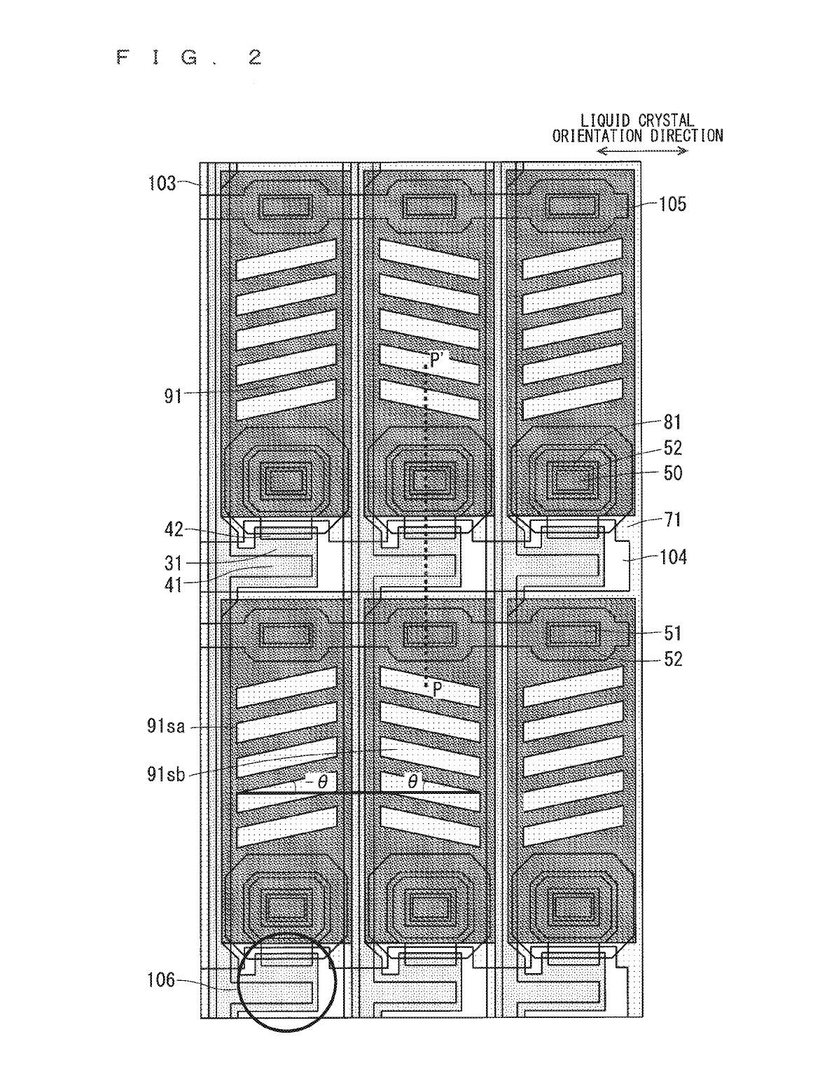

FIG. 2 is a plan view illustrating a configuration of a pixel unit formed in the display area 101. FIG. 2 shows a configuration at a side of a TFT array substrate on which thin film transistors (TFTs) 106 are arranged in a matrix form. The orientation directions of the liquid crystals correspond to the horizontal direction of the drawing.

As shown in FIG. 2, the pixel unit is arranged with a pixel electrode 91 and a counter electrode 71 in an up-and-down relationship (relationship that the pixel electrode 91 and the counter electrode 71 overlap each other in the depth direction of the drawing). A voltage is applied to between the pixel electrode 91 and the counter electrode 71, and which generates an electric field substantially horizontal to the liquid crystal display panel. In the liquid crystal display panel, the electric field is used for drive of the liquid crystal molecules in the horizontal direction to perform display.

The pixel electrode 91 applies a display voltage based on signal data which are input from the outside. It is the thin film transistor 106 that controls the display voltage, and the thin film transistor 106 is arranged on a transparent insulating substrate (not shown) located below the pixel electrode 91 and the counter electrode 71.

The gate electrode of the thin film transistor 106 is connected to the scanning line 104, and the source electrode of the thin film transistor 106 is connected to the signal line 103. The common wire 105 is arranged parallel to the scanning line 104.

Further, a protection insulation film (not shown) is provided on the transparent insulating substrate. The pixel electrode 91 is electrically connected to a drain electrode (not shown) via a contact hole 52 provided in the protection insulation film, and the counter electrode 71 is electrically connected to the common wire 105 via the contact hole 52 provided in the protection insulation film.

In such a configuration, when the control signal is provided from the scanning line 104, an electric current flows between the source electrode and the drain electrode of the thin film transistor 106. The voltage based on the signal data provided from the signal line 103 is applied to the pixel electrode 91.

The signal data provided from the signal line 103 are given from an IC chip 109 connected to the implementation terminal 107 in the frame area 102 (FIG. 1), or the wire substrate 108 connected to the external connection terminal 1071, so that the voltage according to the display data is applied to the pixel electrodes 91.

In the present preferred embodiment, with respect to an upper portion electrode and a lower portion electrode of the liquid crystal display panel in the FFS mode, the upper portion electrode is defined as the pixel electrode 91, and the lower portion electrode is defined as the counter electrode 71. Alternatively, the lower portion electrode may be defined as the pixel electrode 91, and the upper portion electrode may be defined as the counter electrode 71.

In the present preferred embodiment, in the pixel electrode 91, slit-like opening portions are provided so that the generated electric field flows upward, but when the lower portion electrode is defined as the pixel electrode 91, and the upper portion electrode is defined as the counter electrode 71, the counter electrode 71 may be provided with slit-like opening portions which are similar to those provided in the pixel electrode 91.

When the relationship between the position of the slit-like opening portions and the position of the contour portion of the planar pattern of the pixel electrode 91 are in the relationship explained below, the actions and the effects caused thereby are the same.

More specifically, as shown in FIG. 2, the pixel electrodes 91 are arranged with two types of pixels in mixed manner, which include a pixel A arranged with a plurality of slits 91sa and a pixel B arranged with a plurality of slits 91sb.

The longitudinal directions of the slit 91sa and the slit 91sb extend in different directions. In a case where the orientation direction (rubbing direction) of the liquid crystal restricted by rubbing and the like is defined as the reference (0 degrees), and the clockwise (right turn) direction is defined as positive, the slit 91sa is arranged with an inclination of an angle −θ, and the slit 91sb is arranged with an inclination of an angle +θ. In this case, the angle θ is configured to be a relatively low angle which is less than 45 degrees. The pixel A having the plurality of slits 91sa and the pixel B having the plurality of slits 91sb are arranged in proximity to each other.
With such a configuration, the direction of the electric field generated in the liquid crystal layer is different in accordance with the inclination of the slit, and therefore, this can alleviate the change in the color due to the difference of the viewing angle (the observation direction with respect to the panel surface). More specifically, this can alleviate occurrence of the color shift phenomenon.

In the present preferred embodiment, the slit is in the slot shape in the explanation, but the form of the slit is not limited to the slot shape. For example, the slit may be in an L shape (bent shape), or may be in an S shape. More specifically, as long as two types of slit shapes are substantially in a line symmetrical with respect to a reference line (rubbing direction), the change in the color is cancelled by the slits with respect to each other in two types of pixels adjacent to each other, and thus the above actions can be obtained.

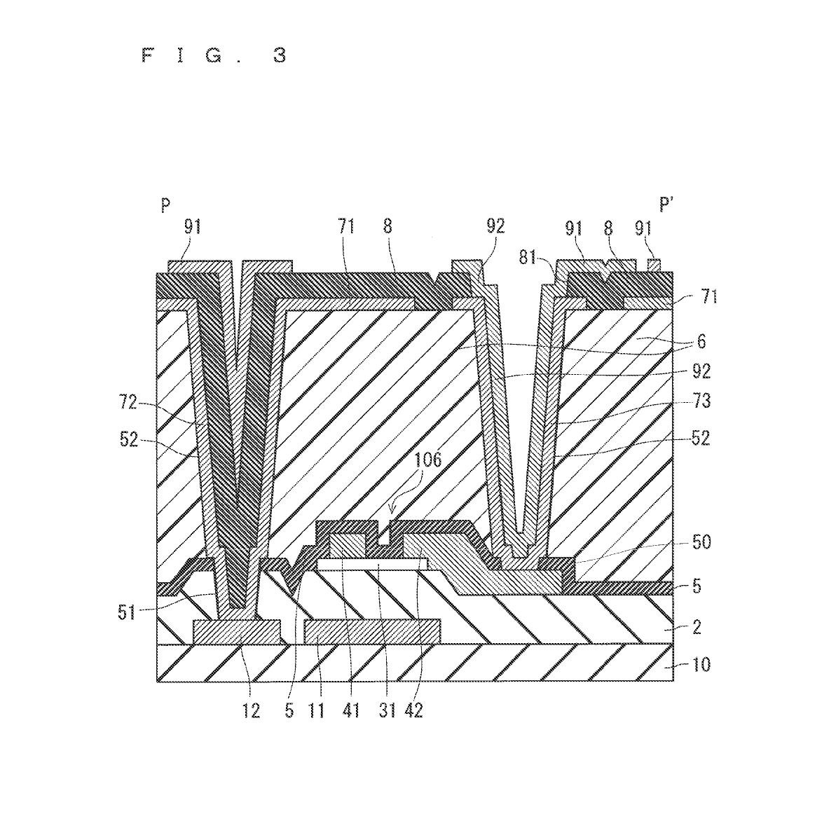

Subsequently, the cross sectional configuration of the pixel unit will be explained with reference to FIG. 3. FIG. 3 is a diagram illustrating a cross sectional view in an arrow direction taken along P-P′ line of FIG. 2.

As shown in FIG. 3, on the transparent insulating substrate 10 of the display area 101, a gate electrode 11 is formed in association with an area where the thin film transistor 106 is formed. In addition, the scanning line 104 (see FIG. 2) extending from the gate electrode 11 is formed, the common wire 105 (see FIG. 1) arranged parallel to the scanning line 104 is formed, and a common wire pad 12 extending from the common wire 105 is formed.

Further, the gate insulation film 2 is formed to cover the gate electrode 11, the scanning line 104, the common wire 105, and the common wire pad 12. The gate insulation film 2 may be, for example, SiN film.

A semiconductor film 31 is formed in an area on the gate insulation film 2 corresponding to the area where the gate electrode 11 is formed. The semiconductor film 31 is constituted by amorphous silicon, microcrystalline silicon, or polycrystalline silicon, or a silicon semiconductor film or an oxide semiconductor film obtained by laminating a combination of one or more of amorphous silicon, microcrystalline silicon, or polycrystalline silicon.

The semiconductor film 31 is divided into the source area and the drain area with the channel area located therebetween, and the source electrode 41 and the drain electrode 42 are formed on the source area and the drain area, respectively.

As described above, the thin film transistor 106 includes the gate electrode 11, the semiconductor film 31, the source electrode 41, and the drain electrode 42.

On the gate insulation film 2, the signal line 103 (see FIG. 2) is formed. The signal line 103 is formed of a metal film of the same material as the source electrode 41 and the drain electrode 42. Further, a protection insulation film 5 is formed to entirely cover the thin film transistor 106 and the signal line 103. The protection insulation film 5 is an inorganic insulation film, and is formed with, e.g., a single-layer film of an SiN film or multi-layer film (for example, a multi-layer film of an SiO film and an SiN film).

A planarized film 6 is formed on the protection insulation film 5. The SiN film constituting the protection insulation film 5 prevents the property of the thin film transistor 106 from being degraded due to moisture and the like from the planarized film 6. The planarized film 6 is formed to cover the signal line 103, the scanning line 104, and the common wire 105, and the formed depression/projection shape is planarized by the thickness of the wire layers themselves. The planarized film 6 forms a planarized surface on the TFT array substrate surface of the upper surface of the signal line 103, the scanning line 104, and the common wire 105.

The planarized film 6 is an organic resin film mainly made of acrylic or an SOG (spin on glass) film. This is because, in the present preferred embodiment, one of the lower layer side of the counter electrode 71 and the pixel electrode 91 is arranged with the planarized film 6 located therebetween so as to overlap the scanning line 104 and the signal line 103 in a planar manner.

With such a configuration, the pixel electrode 91 may be affected by the noise given by the signal line 103, and this may reduce the quality of the display. When the parasitic capacitance between the pixel electrode 91 and the scanning line 104 or the signal line 103 is equal to or more than a certain level, there may occur an disadvantage in that the write speed of the signal to the pixel electrode 91 may decrease.

Therefore, the planarized film 6 that determines the parasitic capacitance between the counter electrode 71 and the scanning line 104 or the signal line 103 and the parasitic capacitance between the pixel electrode 91 and the scanning line 104 or the signal line 103 may desirably have a film thickness equal to or more than at least 1 μm. Therefore, the material forming the planarized film 6 is desirably a material that can be formed by application, and is desirably have a lower dielectric constant ∉.

The relative dielectric constants of the acrylic resin or SOG film is about 3 to 4, which is lower than 6 to 7 of the SiN film, and is advantageous in reducing the parasitic capacitance. It should be noted that the acrylic resin is highly transparent, and is inexpensive. The acrylic resin can be used as an application film by solving an organic solvent, and therefore, the acrylic resin can be easily treated, and such a property that it can be fired at a relatively low temperature.

The SiO2 film formed by the CVD method, the sputtering method, and the like also have the dielectric constants which is about the same as that of the SOG film, but it is difficult to obtain a film thickness equal to or more than 1 μm. Moreover, it has such a property that it is difficult to planarize the film in the same manner as the SiN film.

The counter electrode 71 constituted by a transparent conductive film such as ITO (Indium Tin Oxide) or IZO (Indium Zinc Oxide) is formed on the planarized film 6 having the planarized surface, and a layer isolation film 8 is formed on the planarized film 6 so as to cover the counter electrode 71. The pixel electrode 91 constituted by a transparent conductive film such as ITO or IZO is formed on the layer isolation film 8.

As shown in FIG. 3, a contact hole 50 is formed to penetrate through the protection insulation film 5 on the drain electrode 42 to reach the drain electrode 42. A contact hole 51 is formed to penetrate through the gate insulation film 2 and the protection insulation film 5 on the common wire pad 12.

The counter electrode 71 and the pixel electrode 91 constituted by the transparent conductive film such as ITO or IZO connect to the drain electrode 42 and the common wire pad 12 via the contact holes 50 and 51.

The layer isolation film 8 is formed between the counter electrode 71 and the pixel electrode 91 inserted into the contact hole 51. The layer isolation film 8 maintains insulation between both of the electrodes, and makes an accumulation capacitance contributing to electrical charge held by the pixel electrode 91.

As shown in FIG. 3 the contact hole 52 is formed in the planarized film 6 on the protection insulation film 5, so that the planarized film 6 does not come into direct contact with the metal film such as the drain electrode 42 or the common wire pad 12, and the contact hole 52 is configured to be in communication with the contact hole 50 and the contact hole 51.

The common wire pad 12 and the transparent conductive film 72 extending from the counter electrode 71 are electrically connected via the contact hole 52 and the contact hole 51, so that the counter electrode 71 is connected to the common wire pad 12. The transparent conductive film 72 extending from the counter electrode 71 covers the inner wall side surface of the contact hole 52 and the contact hole 51, and covers the surface of the common wire pad 12 exposed on the bottom surface portion of the contact hole 51, so that the transparent conductive film 72 is electrically connected to the common wire pad 12.

In addition, the transparent conductive film 73 covers the inner wall side surface of the contact hole 50 and the contact hole 52, and covers the surface of the drain electrode 42 exposed on the bottom surface portion of the contact hole 50. The transparent conductive film 73 is formed with the same material as the counter electrode 71, but the transparent conductive film 73 is electrically independent from the counter electrode 71.

The pixel electrode 91 inserted into the contact hole 81 formed on the layer isolation film 8 above the contact hole 52 is electrically connected to the transparent conductive film 73 covering the contact hole 50 and the contact hole 52. The pixel electrode 91 is electrically connected to the drain electrode 42.

The transparent conductive film 92 extending from the pixel electrode 91, the transparent conductive film 73, and the drain electrode 42 are electrically connected via the contact hole 81, the contact hole 52, and the contact hole 50, so that the pixel electrode 91 is connected to the drain electrode 42. The transparent conductive film 92 extending from the pixel electrode 91 covers the inner wall side surface of the contact hole 81 and the contact hole 52 and further covers the transparent conductive film 73 covering the inner surface of the contact hole 50 and the contact hole 52. The inner wall side surface of the contact hole 50 and the contact hole 52 and the bottom portion of the contact hole 50 are covered with a laminated film of the transparent conductive film 73 and the transparent conductive film 92.

Such a configuration can prevent the metal film constituting the drain electrode 42 and the common wire pad 12 from being corroded due to moisture of the planarized film 6.

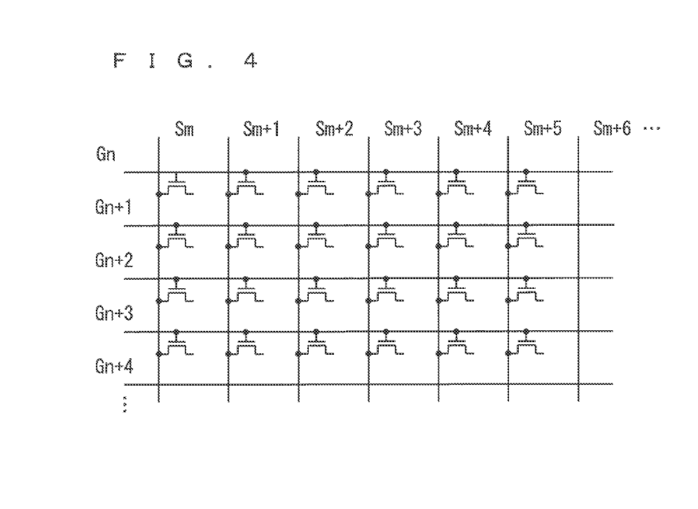

FIG. 4 illustrates an arrangement of TFTs 106 formed in the display area 101 on the TFT array substrate of the liquid crystal display device according to the first preferred embodiment.

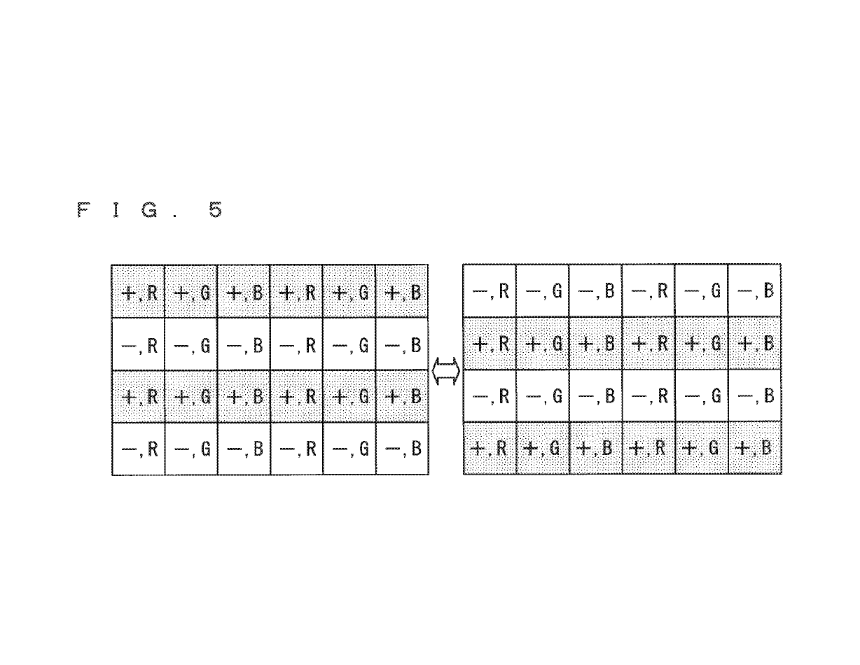

FIG. 5 illustrates an arrangement of the polarities of the pixels and the color materials during line inversion driving in the liquid crystal display device having the TFTs 106 arranged as shown in FIG. 4 and the color materials arranged in an RGB vertical stripe.

The polarities allocated to the pixels are such that the positive polarity (+) and the negative polarity (−) are switched alternately for each frame, and therefore FIG. 5 illustrates two types of arrangements (states).

In this case, since the brightness of a pixel differs depending on the polarity thereof, there is a problem of brightness/darkness difference (flicker) caused by a frame cycle in a frame inversion driving in which all the pixels in the display area have the same polarity. In order to solve this problem, it is desired to not only average the brightness difference in terms of space but also average the brightness difference in terms of time.

More specifically, the flicker can be prevented when the same number of positive polarities (+) and negative polarities (−) are arranged, and the display area of the positive polarity (+) and the display area of the negative polarity (−) are further divided. In the case as shown in FIG. 5, in the line inversion driving, there is no brightness difference of the frame cycle, and the brightness is averaged by the positive polarity (+) and the negative polarity (−) adjacent to each other in the vertical direction in terms of space, so that the flicker is prevented.

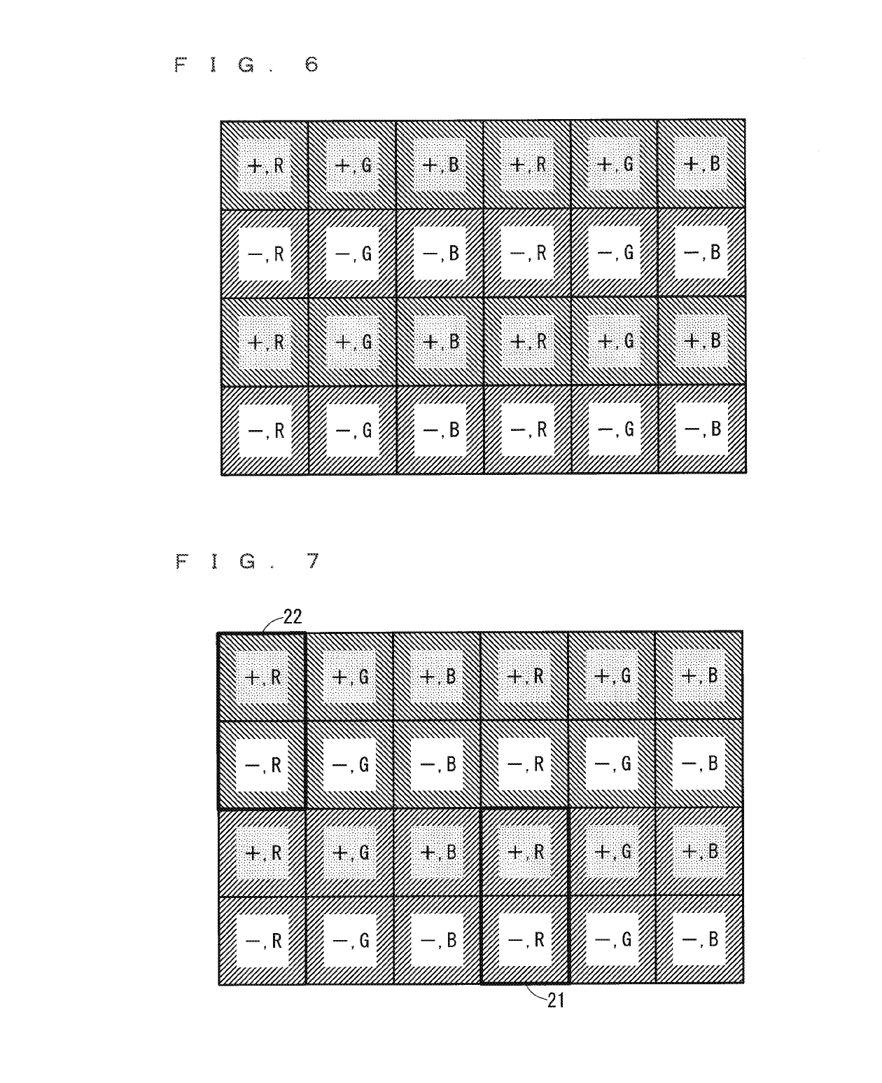

FIG. 6 illustrates arrangement of pixels A (diagonally right up hatching) having slits 91sa having an inclination angle (with the orientation direction of the liquid crystal adopted as the reference) −θ and pixels B (diagonally right down hatching) having slits 91sb having an inclination angle +0 in the liquid crystal display device which has TFTs 106 arranged as shown in FIG. 4, which has color materials arranged in the RGB vertical stripe, and which is line inversion driven.

In the arrangement method of the two types of pixels as shown in FIG. 6, the two types of pixels are arranged alternately in each pixel (for example, the first line is the pixels B (diagonally right down hatching), the second line is the pixels A (diagonally right up hatching)). As shown in FIG. 6, in line inversion driving, the positive polarity (+) and the negative polarity (−) are also arranged alternately in each line (for example, the first line is the positive polarity, and the second line is the negative polarity). Therefore, all the pixels A are the positive polarity (+) or the negative polarity (−), and likewise, all the pixels B are the negative polarity (−) or the positive polarity (+).

Therefore, in the arrangement as shown in FIG. 6, color-shifted flicker may be seen with a certain viewing angle. This is because, as described above, the pixel A and the pixel B are arranged adjacent to each other, so that the effect of reducing the color shift can be obtained, and the positive polarity (+) and the negative polarity (−) are arranged adjacent to each other, so that the effect of reducing the flicker can be obtained.

<Polarity Paring of (+) and (−)>

FIG. 7 illustrates arrangement of two types of pixels of the pixels A having the slits 91sa and the pixels B having the slits 91sb of which inclination angles are different from each other, in the liquid crystal display device which has TFTs 106 arranged as shown in FIG. 4, which has color materials arranged in the RGB vertical stripe, and which is line inversion driven. As shown in FIG. 7, two types of pixels (the pixels A having the slits 91sa and the pixels B having the slits 91sb) are arranged alternately for every two line in the column direction.

More specifically, the pixels B having the slits 91sb are all arranged in the first line and the second line, so that in the arrangement, the pixels B are allocated to both of the positive polarity and the negative polarity.

The pixels A having the slits 91sa are all arranged in the third line and the fourth line, so that in the arrangement, the pixels A are allocated to both of the positive polarity and the negative polarity.

In the arrangement, with respect to the pixels of the positive polarity, the pixels A and the pixels B are allocated alternately in the column direction, and likewise, with respect to the pixels of the negative polarity, the pixels A and the pixels B are allocated alternately in the column direction.

In such a pixel arrangement, the positive polarity (+) and the negative polarity (−) are adjacent to each other in the column direction in both of the cases of the pixel A and the pixel B, and therefore, not only the effect of reducing the flicker but also the effect of reducing the color shift can be obtained.

<Picture Element Made into Unit>

Subsequently, another example of arrangement of two types of pixels of the pixels having slits of which inclination angles are different from each other, in the liquid crystal display device which has TFTs 106 arranged as shown in FIG. 4, which has color materials arranged in the RGB vertical stripe, and which is line inversion driven.

In the alternate arrangement of two types of pixels (the pixel A and the pixel B) arranged alternately for every two lines according to the present preferred embodiment, the resolution may be reduced as compared with the alternate arrangement for each line, and therefore, the effect of reducing the color shift may be weakened.

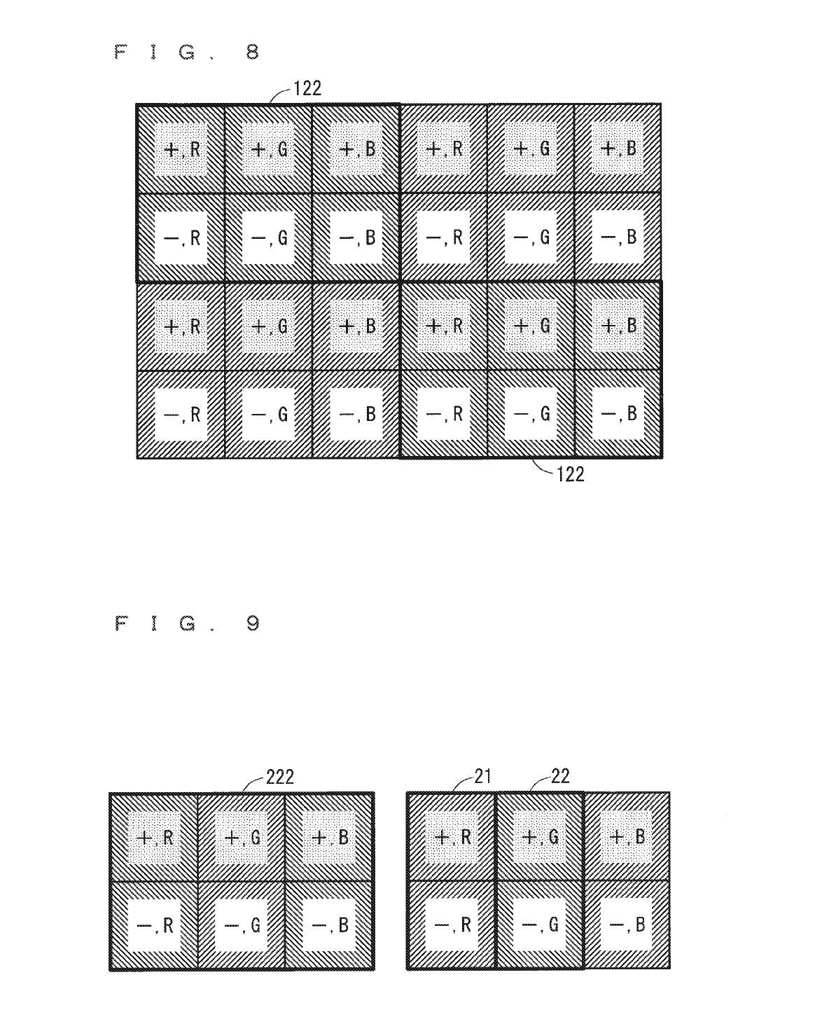

Accordingly, as shown in FIG. 8, the pixels A form a polarity area (first polarity area) while a plurality of polarity units 21 make one area, and the pixels B form a polarity area 122 (second polarity area) while as many polarity units 22 as the number of the polarity units 21 in the polarity area made of the pixels A make one area. In FIG. 8, the polarity areas 122 and polarity areas other than those are alternately arranged.

Then, the polarity areas are arranged in a staggered manner (zigzag manner) with respect to each other. FIG. 8 illustrates a state that the polarity areas 122 are arranged in a staggered manner while three RGB pixels adjacent to each other (picture element) make one area. In other words, the polarity areas other than the polarity area 122 (first polarity area) are also arranged in a staggered manner.

When such a configuration of pixel arrangement is employed, two types of pixels (the pixels A and the pixels B) are also arranged not only in the column direction but also in the row direction, and therefore, the effect of reducing the color shift can also be obtained in the row direction.

<Pixel Mixing in Picture Element Unit>

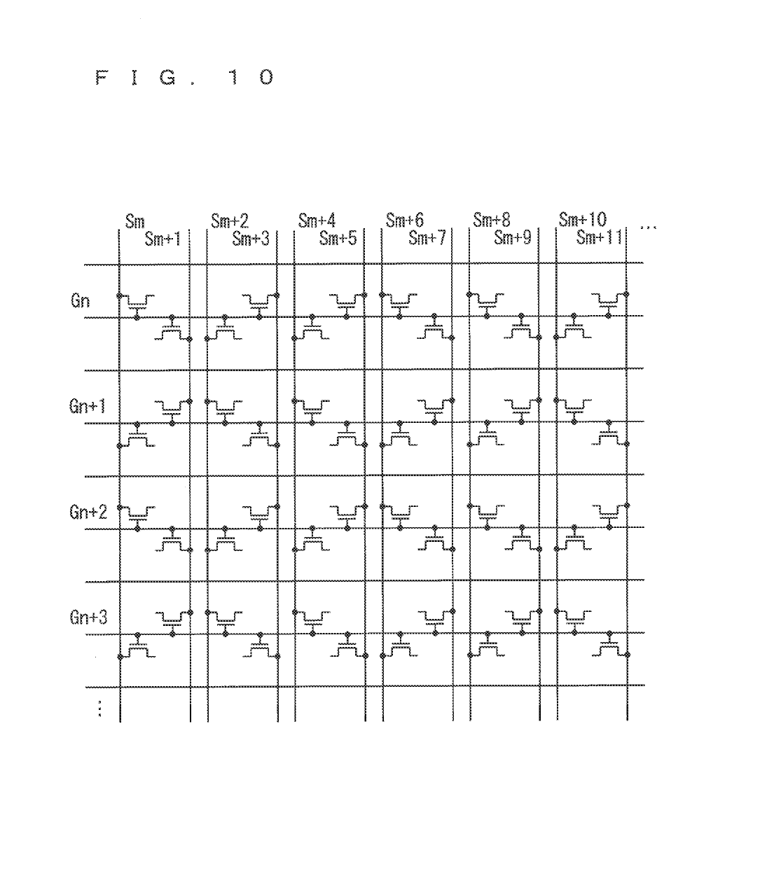

FIG. 9 illustrates a state that the polarity units 21 and the polarity units 22 are alternately arranged in the liquid crystal display device which has TFTs 106 arranged as shown in FIG. 4, which has color materials arranged in the RGB vertical stripe, and which is line inversion driven.

In other words, three RGB pixels adjacent to one another (picture element) make one area, and the polarity areas 222 are arranged in a staggered manner. In the polarity area 222, the polarity units 21 and the polarity units 22 exist in a mixed manner, and, for example, these polarity units are arranged alternately in the row direction.

The polarity areas other than the polarity area 222 (fourth polarity area) are also arranged in a staggered manner, and the arrangement of the pixels in the area has such a relationship that the pixel A and the pixel B of the pixel arrangement in the polarity area 222 are replaced with each other. The polarity areas 222 and the polarity areas other than the polarity area 222 are arranged alternately in the row direction and the column direction.

When such a configuration of pixel arrangement is employed, the effect of reducing the color shift can be obtained not only in the column direction but also in the row direction.

<Effect>

According to the present preferred embodiment, in a liquid crystal display device including a plurality of pixels arranged on a substrate (transparent insulating substrate 10), and rotating and controlling liquid crystal molecules within a plane parallel to the transparent insulating substrate 10 in each pixel, each pixel includes a liquid crystal layer, a pixel electrode 91 arranged below the liquid crystal layer, and a counter electrode 71 arranged below the pixel electrode 91 with an insulation film (layer isolation film 8) located therebetween.

Among the plurality of pixels, pixels having a first slit (slit 91sa) formed to have an inclination angle with respect to a rubbing direction in the pixel electrode 91 will be defined as first pixels (A), and pixels having a second slit (slit 91sb) formed to have an inclination angle opposite to the slit 91sa with respect to the rubbing direction in the pixel electrode 91 will be defined as second pixels (B).

At this occasion, in a case where a positive polarity or a negative polarity is allocated to each pixel for each frame, a pixel A having the positive polarity allocated thereto and a pixel A having the negative polarity allocated thereto exist in the same frame, and a pixel B having the positive polarity allocated thereto and a pixel B having the negative polarity allocated thereto exist in the same frame.

In such a configuration, the color shift can be reduced without decreasing the transmittance of each pixel, and furthermore, both of the positive and negative polarities are allocated to two types of pixels, so that the flicker can also be suppressed.

According to the present preferred embodiment, each of arrangements in which the first pixel (A) having the positive polarity allocated thereto and the pixel A having the negative polarity allocated thereto are arranged adjacent to each other in the column direction will be defined as a first polarity unit (polarity unit 21), and each of arrangements in which the second pixel (B) having the positive polarity allocated thereto and the pixel B having the negative polarity allocated thereto are arranged adjacent to each other in the column direction will be defined as a second polarity unit (polarity unit 22).

At this occasion, the polarity units 21 and the polarity units 22 are arranged alternately in the column direction.

According to such a configuration, both of the positive polarity and the negative polarity are allocated to two types of pixels, and therefore, the color shift and the flicker can be reduced.

According to the present preferred embodiment, the polarity units 21 or the polarity units 22 are arranged in the row direction on the substrate (transparent insulating substrate 10).

According to such a configuration, both of the positive polarity and the negative polarity are allocated to two types of pixels, and therefore, the color shift and the flicker can be reduced.

According to the present preferred embodiment, the first polarity areas each including polarity units 21 and the second polarity areas (polarity area 122) each including as many polarity units 22 as the number of the polarity units 21 in the first polarity area are arranged alternately.

According to such a configuration, two types of pixels are arranged in the column direction and the row direction, and therefore, the color shift and the flicker can be reduced.

According to the present preferred embodiment, the first polarity areas and the polarity areas 122 are each arranged in a staggered manner.

According to such a configuration, two types of pixels are arranged in the column direction and the row direction, and therefore, the color shift and the flicker can be reduced.

According to the present preferred embodiment, areas each including at least one of the polarity units 21 and at least one of the polarity units 22 will be defined as third polarity areas (polarity area 222), and areas each including as many polarity units 21 as the number of the polarity units 22 in the polarity area 222 and as many polarity units 22 as the number of the polarity units 21 in the polarity area 222 will be defined as fourth polarity areas.

At this occasion, the polarity areas 222 and the fourth polarity areas are arranged alternately.

According to such a configuration, two types of pixels are arranged in the column direction and the row direction, and therefore, the color shift and the flicker can be reduced.

According to the present preferred embodiment, the polarity areas 222 and the fourth polarity areas are each arranged in a staggered manner.

According to such a configuration, two types of pixels are arranged in the column direction and the row direction, and therefore, the color shift and the flicker can be reduced.

### Second Preferred Embodiment

<Configuration>

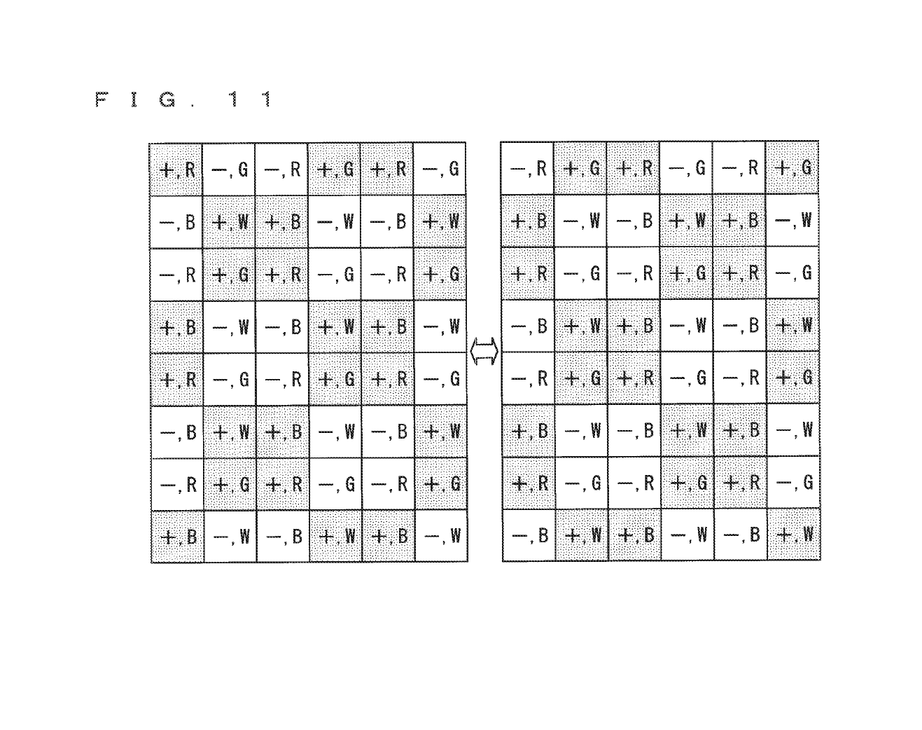

FIG. 10 illustrates an arrangement of TFTs 106 formed in a display area 101 on a TFT array substrate of a liquid crystal display device according to a second preferred embodiment.

In FIG. 4, one pixel is constituted by arranging the gate wire, the source wire, and the TFT 106. In FIG. 10, two pixels are constituted by arranging one gate wire, two source wires, and two TFTs 106. As shown in FIG. 10, there are four types of arrangement positions of the TFTs 106 in the pixel, and the arrangement is 4 by 4 pixel cycle.

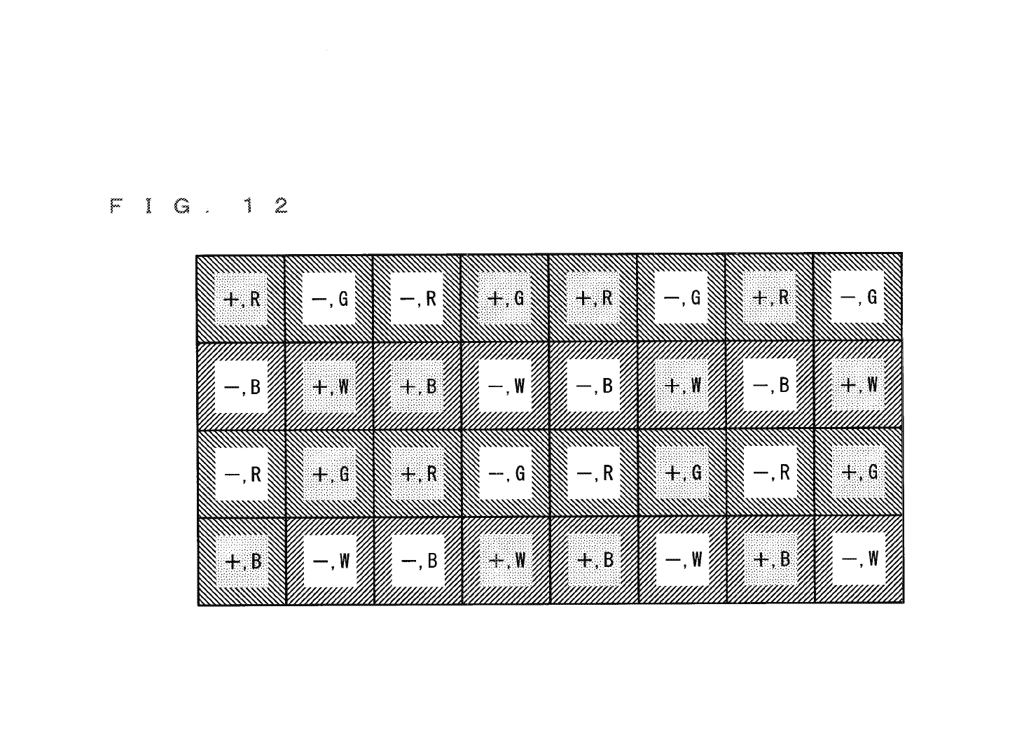

FIG. 11 illustrates an arrangement of the polarities of the pixels and the color materials during column inversion driving in the liquid crystal display device including the TFTs 106 arranged as shown in FIG. 10 and including the color materials (RGBW) arranged in 2 by 2 arrangement.

The polarities of the pixels are such that the positive polarity (+) and the negative polarity (−) are switched for each frame, and therefore FIG. 11 illustrates two types of arrangements (states).

As shown in FIG. 11, a picture element constituted by 2 by 2 pixels is arranged such that picture elements adjacent to each other in the vertical and horizontal directions have polarities opposite to each other. Therefore, when seen from at least from front side, the flicker cannot be seen.

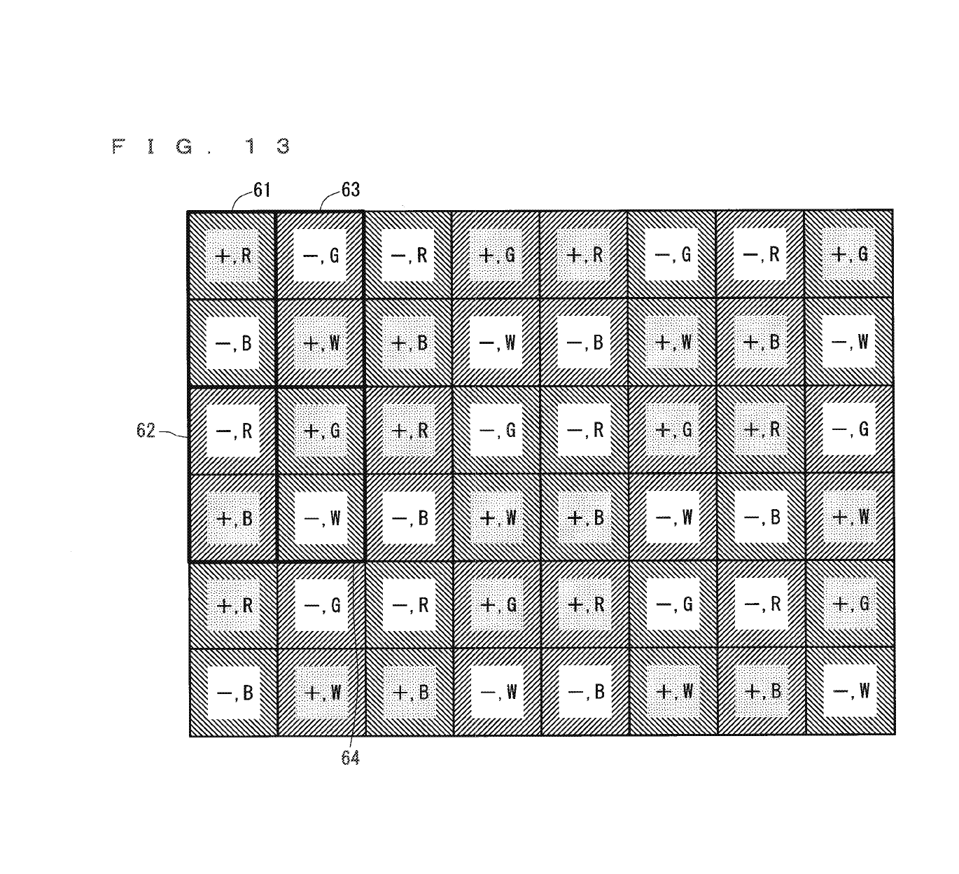

In the arrangement method of two types of pixels as shown in FIG. 12, two types of pixels are arranged alternately for each row (for example, the first line is the pixels B (diagonally right down hatching), and the second line is the pixels A (diagonally right up hatching)). In this case, one picture element is constituted by 2 by 2 pixels, and therefore, as shown in FIG. 12, color materials and two types of pixels are both arranged in two-row cycle. Therefore, for each color material, any color material is constituted by only the pixel A or the pixel B, and the effect of reducing the color shift may not be sufficient.

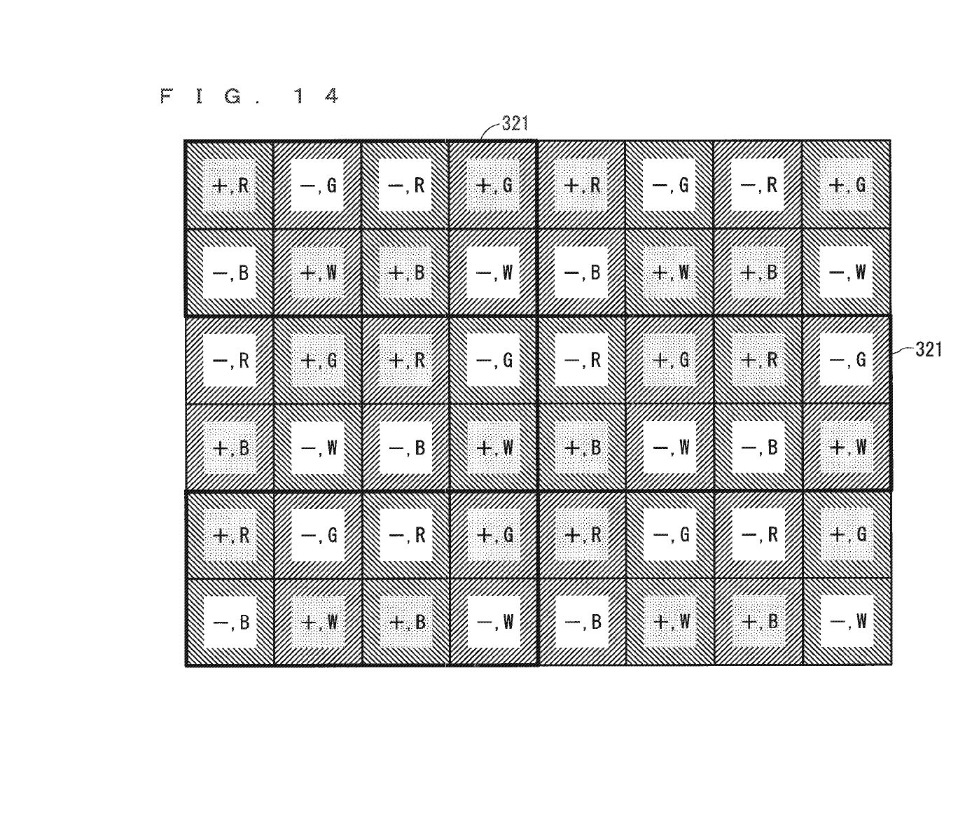

FIG. 13 illustrates an arrangement of two types of pixels having slits of which inclination angles are different from each other in the liquid crystal display device which has TFTs 106 arranged as shown in FIG. 10, which has color materials (RGBW) arranged in 2 by 2, and which is column inversion driven.

The arrangement in which the pixel A to which R color material is allocated (positive polarity) and the pixel A to which B color material is allocated (negative polarity) are adjacent to each other in the column direction is the color material unit 61. Likewise, the arrangement in which the pixel B to which R color material is allocated (negative polarity) and the pixel B to which B color material is allocated (positive polarity) are adjacent to each other in the column direction is the color material unit 62. Then, as shown in FIG. 13, it is understood that the color material units 61 and the color material units 62 are arranged alternately in the column direction. In such an arrangement, the color materials are allocated to both of the pixel A and the pixel B in prolixity to each other in the column direction, and therefore, the effect of reducing the color shift can be obtained.

The arrangement in which the pixel B to which G color material is allocated (negative polarity) and the pixel B to which W color material is allocated (positive polarity) are adjacent to each other in the column direction is the color material unit 63. Likewise, the arrangement in which the pixel A to which G color material is allocated (positive polarity) and the pixel A to which W color material is allocated (negative polarity) are adjacent to each other in the column direction is the color material unit 64. Then, as shown in FIG. 13, it is understood that the color material units 63 and the color material units 64 are arranged alternately in the column direction. In such an arrangement, the color materials are allocated to both of the pixel A and the pixel B in proximity to each other in the column direction, and therefore, the effect of reducing the color shift can be obtained.

In the example of arrangement of as shown in FIG. 13, two adjacent picture elements make one area, and the color material area can be formed.

In the example of arrangement of as shown in FIG. 14, two picture elements adjacent to each other in the row direction make one area (color material area 321), and arranged in a staggered manner. In the color material area 321, the color material unit 61 and the color material unit 63 exist in a mixed manner, and, for example, these polarity units are arranged alternately in the row direction. In such an arrangement, in the case of the pixel A or the pixel B for each color materials, pixels are allocated to both of the positive polarity (+) and the negative polarity (−) in proximity to each other in the row direction, and therefore, the effect of reducing the flicker can be obtained.

The color material areas other than the color material area 321 (second color material area) are also arranged in a staggered manner, and the arrangement of the pixels in the area has such a relationship that the pixel A and the pixel B of the pixel arrangement in the color material area 321 are replaced with each other. The color material areas 321 and the other color material areas are arranged alternately in the row direction and the column direction.

In this case, combinations of two types of pixels having slits of which inclination angles are different from each other and having polarities of pixels (two types which include the positive and the negative) and color materials (four types which include R, G, B, and W) is totally (2×4×2=) 16 combinations. With this configuration having the pixel arrangement explained above, the pixels of all the combinations are arranged in the 2 by 2 picture element (4 by 4 pixels). More specifically, not only the effect of reducing the flicker but also the effect of reducing the color shift can be obtained.

It should be noted that the arrangement of the two types of pixels in each color material area is not limited to the configuration of the present preferred embodiment. Although not shown in the drawings, a configuration of a color material area including only the pixels A and a color material area including only the pixel B or a configuration of other combinations may also be possible like the present preferred embodiment.

<Effect>

According to the present preferred embodiment, in a liquid crystal display device including a plurality of pixels arranged on a substrate (transparent insulating substrate 10), and rotating and controlling liquid crystal molecules within a plane parallel to the transparent insulating substrate 10 in each pixel, each pixel includes a liquid crystal layer, a pixel electrode 91 arranged below the liquid crystal layer, and a counter electrode 71 arranged below the pixel electrode 91 with an insulation film (layer isolation film 8) located therebetween.

Among the plurality of pixels, pixels having a first slit (slit 91sa) formed to have an inclination angle with respect to a rubbing direction in the pixel electrode 91 will be defined as first pixels (A), and pixels having a second slit (slit 91sb) formed to have an inclination angle opposite to the slit 91sa with respect to the rubbing direction in the pixel electrode 91 will be defined as second pixels (B).

At this occasion, in a case where any one of a plurality of types of color materials is allocated to each pixel, all the types of the plurality of color materials are allocated to both of at least one of the pixels A and the pixels B.

According to such a configuration, all the color materials are allocated to each of the two types of pixels, and therefore the color shift can be suppressed.

According to the present preferred embodiment, each of arrangements in which a pixel A having a first color materials (R) of a plurality of types of color materials allocated thereto and a pixel A having a second color materials (B) of a plurality of types of color materials allocated thereto are arranged adjacent to each other in the column direction will be defined as a first color material unit (color material unit 61).

On the other hand, each of arrangements in which a pixel B having a color material R of a plurality of types of color materials allocated thereto and a pixel B having a color material B of a plurality of types of color materials allocated thereto are arranged adjacent to each other in the column direction will be defined as a second color material unit (color material unit 62).

At this occasion, the color material units 61 and the color material units 62 are arranged alternately in the column direction.

Each of arrangements in which a pixel B having a third color material (G) of a plurality of types of color materials allocated thereto and a pixel B having a fourth color material (W) of a plurality of types of color materials allocated thereto are arranged adjacent to each other in the column direction will be defined as a third color material unit (color material unit 63).

Each of arrangements in which a pixel A having a color material G of a plurality of types of color materials allocated thereto and a pixel A having a color material W of a plurality of types of color materials allocated thereto are arranged adjacent to each other in the column direction will be defined as a fourth color material unit (color material unit 64).

At this occasion, the color material units 63 and the color material units 64 are arranged alternately in the column direction.

Areas each including two picture elements adjacent to each other in the row direction (two color material units 61 and two color material units 63) will be defined as first color material areas (color material area 321).

Areas each including as many color material units 62 as the color material units 61 in the color material area 321 and as many color material units 64 as the color material units 63 in the color material area 321 will be defined as second color material areas.

At this occasion, the color material areas 321 and the second color material areas are arranged alternately.

According to such a configuration, two types of pixels are arranged in the column direction and the row direction, and all the color materials are allocated to each of the positive polarity and the negative polarity in the two types of pixels, and therefore, the color shift and the flicker can be reduced.

According to the present preferred embodiment, the color material areas 321 and the second color material areas are each arranged in a staggered manner.

According to such a configuration, two types of pixels are arranged in the column direction and the row direction, and all the color materials are allocated to each of the positive polarity and the negative polarity in the two types of pixels, and therefore, the color shift and the flicker can be reduced.

In the preferred embodiment explained above, the material, the condition of embodiment, and the like of each constituent element are described, but are merely examples. The material, the condition of embodiment, and the like of each constituent element are not limited to what have been described.

While the invention has been shown and described in detail, the foregoing description is in all aspects illustrative and not restrictive. It is therefore understood that numerous modifications and variations can be devised without departing from the scope of the invention.

What is claimed is:

1. A liquid crystal display device including a plurality of pixels arranged on a substrate, and rotating and controlling a liquid crystal molecule within a plane parallel to said substrate in each of said pixels,
each of said pixels comprising:
a liquid crystal layer;
a pixel electrode arranged below said liquid crystal layer; and
a counter electrode arranged below said pixel electrode with an insulation film located therebetween, wherein
pixels of the plurality of said pixels having a first slit formed to have an inclination angle with respect to a rubbing direction in said pixel electrode are defined as first pixels,
pixels of the plurality of said pixels having a second slit formed to have an inclination angle opposite to said first slit with respect to the rubbing direction in said pixel electrode are defined as second pixels, and
in a case where a positive polarity or a negative polarity is allocated to each of said pixels for each frame, at least one of said first pixels having said positive polarity allocated thereto and at least one of said first pixels having said negative polarity allocated thereto exist in the same frame, and at least one of said second pixels having said positive polarity allocated thereto and at least one of said second pixels having said negative polarity allocated thereto exist in the same frame.

2. The liquid crystal display device according to claim 1, wherein
Each of arrangements in which said first pixel having said positive polarity allocated thereto and said first pixel having said negative polarity allocated thereto are adjacent to each other in a column direction is defined as a first polarity unit,
Each of arrangements in which said second pixel having said positive polarity allocated thereto and said second pixel having said negative polarity allocated thereto are adjacent to each other in the column direction is defined as a second polarity unit, and
said first polarity units and said second polarity units are arranged alternately in the column direction.

3. The liquid crystal display device according to claim 2, wherein said first polarity units or said second polarity units are arranged in the row direction of said substrate.

4. The liquid crystal display device according to claim 2, wherein first polarity areas each including said first polarity units and second polarity areas each including as many said second polarity units as said first polarity units in said first polarity area are arranged alternately.

5. The liquid crystal display device according to claim 4, wherein said first polarity areas and said second polarity areas are each arranged in a staggered manner.

6. The liquid crystal display device according to claim 2, wherein
areas each including at least one of said first polarity units and at least one of said second polarity units are defined as third polarity areas,
areas each including as many said first polarity units as said second polarity units in said third polarity area and as many said second polarity units as said first polarity units in said third polarity area are defined as a fourth polarity areas, and
said third polarity areas and said fourth polarity areas are arranged alternately.

7. The liquid crystal display device according to claim 6, wherein said third polarity areas and said fourth polarity areas are each arranged in a staggered manner.

8. The liquid crystal display device according to claim 1, wherein in a case where any one of a plurality of types of color materials is allocated to each of said pixels, said plurality of types of color materials are all allocated to both of at least one of said first pixels and at least one of said second pixels.

9. The liquid crystal display device according to claim 8, wherein
each of arrangements in which said first pixel having a first color material of said plurality of types of color materials allocated thereto and said first pixel having a second color material of said plurality of types of color materials allocated thereto are adjacent to each other in the column direction is defined as a first color material unit,
each of arrangements in which said second pixel having the first color material of said plurality of types of color materials allocated thereto and said second pixel having the second color material of said plurality of types of color materials allocated thereto are adjacent to each other in the column direction is defined as a second color material unit,
said first color material units and said second color material units are arranged alternately in the column direction,
each of arrangements in which said second pixel having a third color material of said plurality of types of color materials allocated thereto and said second pixel having a fourth color material of said plurality of types of color materials allocated thereto are adjacent to each other in the column direction is defined as a third color material unit,
each of arrangements in which said first pixel having the third color material of said plurality of types of color materials allocated thereto and said first pixel having the fourth color material of said plurality of types of color materials allocated thereto are adjacent to each other in the column direction is defined as a fourth color material unit,
said third color material units and said fourth color material units are arranged alternately in the column direction,
areas each including at least one of said first color material units and at least one of said third color material units are defined as first color material areas,
areas each including as many said second color material units as said first color material units in said first color material area and as many said fourth color material units as said third color material units in said first color material area are defined as second color material areas, and
said first color material areas and said second color material areas are arranged alternately.

10. The liquid crystal display device according to claim 9, wherein said first color material areas and said second color material areas are each arranged in a staggered manner.

11. A liquid crystal display device including a plurality of pixels arranged on a substrate, and rotating and controlling a liquid crystal molecule within a plane parallel to said substrate in each of said pixels,
each of said pixels comprising:
a liquid crystal layer;
a pixel electrode arranged below said liquid crystal layer; and
a counter electrode arranged below said pixel electrode with an insulation film located therebetween, wherein
pixels of the plurality of said pixels having a first slit formed to have an inclination angle with respect to a rubbing direction in said pixel electrode are defined as first pixels,
pixels of the plurality of said pixels having a second slit formed to have an inclination angle opposite to said first slit with respect to the rubbing direction in said pixel electrode are defined as a second pixels, and
in a case where any one of a plurality of types of color materials is allocated to each of said pixels, said plurality of types of color materials are all allocated to both of at least one of said first pixels and at least one of said second pixels.

12. A liquid crystal display device including a plurality of pixels arranged on a substrate, and rotating and controlling a liquid crystal molecule within a plane parallel to said substrate in each of said pixels,
each of said pixels comprising:
a liquid crystal layer;
a counter electrode arranged below said liquid crystal layer; and
a pixel electrode arranged below said counter electrode with an insulation film located therebetween, wherein
pixels of the plurality of said pixels having a first slit formed to have an inclination angle with respect to a rubbing direction in said counter electrode are defined as first pixels,
pixels of the plurality of said pixels having a second slit formed to have an inclination angle opposite to said first slit with respect to the rubbing direction in said counter electrode are defined as second pixels,
in a case where a positive polarity or a negative polarity is allocated to each of said pixels for each frame, at least one of said first pixels having said positive polarity allocated thereto and at least one of said first pixels having said negative polarity allocated thereto exist in the same frame, and at least one of said second pixels having said positive polarity allocated thereto and at least one of said second pixels having said negative polarity allocated thereto exist in the same frame.

13. A liquid crystal display device including a plurality of pixels arranged on a substrate, and rotating and controlling a liquid crystal molecule within a plane parallel to said substrate in each of said pixels,
each of said pixels comprising:
a liquid crystal layer;
a counter electrode arranged below said liquid crystal layer; and
a pixel electrode arranged below said counter electrode with an insulation film located therebetween, wherein
pixels of the plurality of said pixels having a first slit formed to have an inclination angle with respect to a rubbing direction in said counter electrode are defined as first pixels,
pixels of the plurality of said pixels having a second slit formed to have an inclination angle opposite to said first slit with respect to the rubbing direction in said counter electrode are defined as second pixels,
in a case where any one of a plurality of types of color materials is allocated to each of said pixels, said plurality of types of color materials are all allocated to both of at least one of said first pixels and at least one of said second pixels.
